(19) United States
(12) Patent Application Publication
(10) Pub. No.: US 2025/0155580 A1
(43) Pub. Date: May 15, 2025

(54) Apparatus for Controlling Vehicle and Method Thereof

(71) Applicants: Hyundai Motor Company, Seoul (KR); Kia Corporation, Seoul (KR)

(72) Inventor: Jun Hyeop Lee, Seoul (KR)

(21) Appl. No.: 18/755,935

(22) Filed: Jun. 27, 2024

(30) Foreign Application Priority Data
Nov. 13, 2023 (KR) 10-2023-0156605

(51) Int. Cl. G01S 17/931; G01S 7/48

(52) U.S. Cl. CPC G01S 17/931; G01S 7/4808

(57) ABSTRACT

The present disclosure may relate to a vehicle control apparatus and a method thereof. The vehicle control apparatus may include a sensor, such as a light detection and ranging (LiDAR) sensor, a memory storing a plurality of models, and a processor. The processor may obtain a point cloud corresponding to a target object via the sensor, match, based on identifying a target model, of the plurality of models, that corresponds to an object type of the target object, a first reference point with a second reference point, determine, based on matching a first heading direction of the point cloud with a second heading direction of the target model, a proportion, of the target model, that overlaps with the point cloud, determine an occlusion level of the point cloud based on the proportion, and output a signal indicating the occlusion level of the point cloud for controlling a vehicle.

### CROSS-REFERENCE TO RELATED APPLICATION

This application claims the benefit of priority to Korean Patent Application No. 10-2023-0156605, filed in the Korean Intellectual Property Office on Nov. 13, 2023, the entire contents of which are incorporated herein by reference.

### TECHNICAL FIELD

The present disclosure relates to a vehicle control apparatus and a method thereof, and more particularly, relates to a technology for using a sensor, such as light detection and ranging (LiDAR).

### BACKGROUND

Various studies are being conducted to identify an external object by using various sensors to assist the driving of a vehicle.

In particular, while the vehicle is driving in a driving assistance device activation mode (e.g., a driving assist mode) or an autonomous driving mode, a target object may be identified by using a sensor, such as a LiDAR.

There is a need to measure an extent, to which the target object is occluded, through the LiDAR. Depending on an extent to which the target object is occluded, a process of changing or maintaining a driving route of the vehicle may be performed by predicting a movement route of the target object.

### SUMMARY

The present disclosure is made to solve the above-mentioned problems occurring in at least some implementations while advantages achieved by those implementations are maintained intact.

An aspect of the present disclosure provides a vehicle control apparatus that may identify an occlusion level of a point cloud corresponding to a target object obtained through a LiDAR, a method thereof.

An aspect of the present disclosure provides a vehicle control apparatus that may accurately and quickly identify the occlusion level of the point cloud by identifying the occlusion level of the point cloud based on using models included in a memory, and a method thereof.

An aspect of the present disclosure provides a vehicle control apparatus that may correct an occlusion level incorrectly labeled in a point cloud, and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: a sensor; memory storing a plurality of models, each model of the plurality of models corresponding to a respective object type; and a processor. The processor may be configured to: obtain, via the sensor, a point cloud corresponding to a target object; match, based on identifying a target model, of the plurality of models, that corresponds to an object type of the target object, a first reference point, which is included in the point cloud and which corresponds to a designated location of the target object, with a second reference point, which is included in the target model and which corresponds to the designated location; and determine, based on matching a first heading direction of the point cloud with a second heading direction of the target model, a proportion, of the target model, that overlaps with the point cloud. Each of the first heading direction and the second heading direction may indicate a moving direction of the target object. The processor may be further configured to determine, based on the proportion, an occlusion level of the point cloud; and, for controlling a vehicle, output a signal indicating the occlusion level of the point cloud.

The processor may be further configured to train a neural network model based on the point cloud and the occlusion level.

The processor may be configured to match the first reference point with the second reference point by: determining a first space in a form of a first hexahedron including the point cloud; determining a second space in a form of a second hexahedron including the target model; determining a first center point, corresponding to an intersection of lines connecting vertices forming the first space, and a second center point, corresponding to an intersection of lines connecting vertices forming the second space; and matching the first reference point with the second reference point based on matching the first center point with the second center point.

The processor may be further configured to: match the first heading direction with the second heading direction based on scaling a first size of the target model to match a second size of the point cloud.

The processor may be configured to: scale the first size of the target model to match the second size of the point cloud based on changing at least one of a width, a length, or a height of the target model.

The processor may be configured to determine the proportion by: determining, based on a horizontal angle range of the sensor, a predetermined horizontal resolution; determining, based on a vertical angle range of the sensor, a predetermined vertical resolution; splitting, based on the predetermined horizontal resolution and the predetermined vertical resolution, the point cloud into grids; and determining, based on the grids, the proportion.

The processor may be configured to determine the proportion further by: determining voxels split by the grids in each of the point cloud and the target model; determining a first shaded area of the point cloud and a second shaded area of the target model; adding, based on identifying a first point corresponding to at least part of the target object in at least part of the first shaded area, a first voxel, including the first point, to a first occupation voxel; adding a second voxel, including a second point corresponding to at least part of the target object in at least part of the second shaded area, to a second occupation voxel; and determining the proportion based on the first occupation voxel and the second occupation voxel. The first shaded area and the second shaded area may be out of a detection range of the sensor. The first occupation voxel may include voxels having at least one point that is identified in the point cloud. The second occupation voxel may include voxels having at least one point that is identified in the target model.

The processor may be further configured to: determine a closest point, among points in the point cloud, to the vehicle; determining, based on applying a predetermined multiplier to a first distance between the vehicle and the closest point, a second distance; and determining the second occupation voxel based on removing any points, from the point cloud, that are at least the second distance away from the vehicle.

The processor may be configured to determine the occlusion level by: determining the occlusion level of the point cloud based on a ratio of the first occupation voxel to the second occupation voxel.

The processor may be further configured to: perform, based on the occlusion level, labeling on the point cloud.

The processor may be further configured to: determine whether to determine the occlusion level, based on at least one of a color of the target object or a distance between the vehicle and the target object.

According to one or more example embodiments of the present disclosure, a vehicle control method may include: obtaining, by a processor via a sensor, a point cloud corresponding to a target object; matching, based on identifying a target model that corresponds to an object type of the target object, a first reference point, which is included in the point cloud and which corresponds to a designated location of the target object, with a second reference point, which is included in the target model and which corresponds to the designated location; and determining, based on matching a first heading direction of the point cloud, with a second heading direction of the target model, a proportion, of the target model, that overlaps with the point cloud. Each of the first heading direction and the second heading direction may indicate a moving direction of the target object. The method may further include determining, based on the proportion, an occlusion level of the point cloud; and, for controlling a vehicle, outputting a signal indicating the occlusion level of the point cloud.

The method may further include training a neural network model based on the point cloud and the occlusion level.

Matching the first reference point with the second reference point may include: determining a first space in a form of a first hexahedron including the point cloud; determining a second space in a form of a second hexahedron including the target model; determining a first center point, corresponding to an intersection of lines connecting vertices forming the first space, and a second center point, corresponding to an intersection of lines connecting vertices forming the second space; and matching the first reference point with the second reference point based on matching the first center point with the second center point.

The method may further include: matching the first heading direction with the second heading direction based on scaling a first size of the target model to match a second size of the point cloud.

Scaling may include: scaling the first size of the target model to match the second size of the point cloud based on changing at least one of a width, a length, or a height of the target model.

Determining the proportion may include: determining, based on a horizontal angle range of the sensor, a predetermined horizontal resolution; determining, based on a vertical angle range of the sensor, a predetermined vertical resolution; splitting, based on the predetermined horizontal resolution and the predetermined vertical resolution, the point cloud into grids; and determining, based on the grids, the proportion.

Determining the proportion may include: determining voxels split by the grids in each of the point cloud and the target model; determining a first shaded area of the point cloud and a second shaded area of the target model; adding, based on identifying a first point corresponding to at least part of the target object in at least part of the first shaded area, a first voxel, including the first point, to a first occupation voxel; adding a second voxel, including a second point corresponding to at least part of the target object in at least part of the second shaded area, to a second occupation voxel; and determining the proportion based on the first occupation voxel and the second occupation voxel. The first shaded area and the second shaded area may be out of a detection range of the sensor. The first occupation voxel may include voxels having at least one point that is identified in the point cloud. The second occupation voxel may include voxels having which at least one point that is identified in the target model.

The method may further include: determining a closest point, among points in the point cloud, to the vehicle; determining, based on applying a predetermined multiplier to a first distance between the vehicle and the closest point, a second distance; determining the second occupation voxel based on removing any points, from the point cloud, that are at least the second distance away from the vehicle; and determining the occlusion level of the point cloud based on a ratio of the first occupation voxel to the second occupation voxel.

The method may further include: determining whether to determine the occlusion level, based on at least one of a color of the target object or a distance between the vehicle and the target object.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus, according to an embodiment of the present disclosure;

FIG. 2 shows an example of models representing objects included in a memory, in an embodiment of the present disclosure;

FIG. 3 shows an example of comparing a point cloud corresponding to a target object and a model corresponding to the type of the target object, in an embodiment of the present disclosure;

FIG. 4 shows an example of determining an occlusion level of a point cloud by using a point cloud and a model, in an embodiment of the present disclosure;

FIG. 5 shows an example of a flowchart associated with a vehicle control method, according to an embodiment of the present disclosure;

FIG. 6 shows an example of applying the present disclosure; and

FIG. 7 shows a computing system related to a vehicle control apparatus or vehicle control method, according to an embodiment of the present disclosure.

### DETAILED DESCRIPTION

Hereinafter, some embodiments of the present disclosure will be described in detail with reference to the accompanying drawings. In adding reference numerals to components of each drawing, it should be noted that the same components include the same reference numerals, although they are indicated on another drawing. Furthermore, in describing the embodiments of the present disclosure, detailed descriptions associated with well-known functions or configurations will be omitted if they may make subject matters of the present disclosure unnecessarily obscure.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

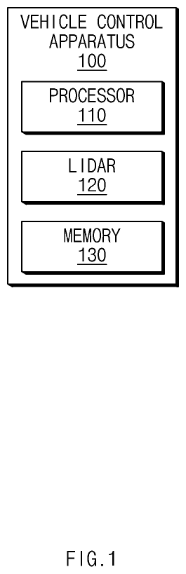

Hereinafter, various embodiments of the present disclosure will be described in detail with reference to FIGS. 1 to 7.

FIG. 1 shows an example of a block diagram associated with a vehicle control apparatus, according to an embodiment of the present disclosure.

Referring to FIG. 1, a vehicle control apparatus 100 according to an embodiment of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 according to an embodiment may include a processor 110, a sensor 120 (e.g., a LiDAR 120), and a memory 130. The processor 110, the sensor 120 (e.g., a LiDAR 120), or the memory 130 may be electrically and/or operably coupled with each other by an electronic component including a communication bus.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, an embodiment is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an embodiment may include hardware for processing data based on one or more instructions. The hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP).

For example, the processor 110 may include a structure of a single-core processor, or may include a structure of a multi-core processor including a dual core, a quad core, a hexa core, or an octa core.

The LiDAR 120 included in the vehicle control apparatus 100 according to an embodiment may obtain data sets from identifying objects surrounding the vehicle control apparatus 100. For example, the LiDAR 120 may identify at least one of a location of the surrounding object, a movement direction of the surrounding object, or a speed of the surrounding object, or any combination thereof based on a pulse laser signal emitted from the LiDAR 120 being reflected by the surrounding object and returned.

For example, the LiDAR 120 may obtain data sets for expressing an external object in the space defined by a first axis, a second axis, and a third axis based on a pulse laser signal reflected from surrounding objects. For example, the first axis may include the x-axis. For example, the second axis may include the y-axis. For example, the third axis may include the z-axis. For example, the first axis, the second axis, and the third axis may be perpendicular to each other and may intersect each other based on an origin point. The first axis, the second axis, and the third axis are not limited to the above examples. Hereinafter, for convenience of description, the first axis is described as the x-axis; the second axis is described as the y-axis; and the third axis is described as the z-axis.

For example, the LiDAR 120 may obtain data sets including a plurality of points in the space, which is formed by the x-axis, the y-axis, and the z-axis, based on receiving the pulse laser signal at a specified period.

The processor 110 included in the vehicle control apparatus 100 according to an embodiment may emit light from a vehicle by using the LiDAR 120. For example, the processor 110 may receive light emitted from the vehicle. For example, the processor 11 may identify at least one of a location, a speed, or a moving direction, or any combination thereof of a surrounding object based on a time required to transmit light emitted from the vehicle and a time required to receive light emitted from the vehicle.

For example, the processor 110 may obtain data sets including a plurality of points based on the time required to transmit light emitted from the vehicle and the time required to receive light emitted from the vehicle. The processor 110 may obtain data sets for expressing a plurality of points in a three-dimensional virtual coordinate system including the x-axis, the y-axis, and the z-axis.

The memory 130 included in the vehicle control apparatus 100 according to an embodiment may include a hardware component for storing data and/or instructions that are to be input and/or output to the processor 110 of the vehicle control apparatus 100.

For example, the memory 130 may include a volatile memory including a random-access memory (RAM), or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

In an embodiment, the memory 130 may include models representing objects. For example, the models representing objects may include models representing objects by using a three-dimensional virtual coordinate system. For example, the models representing objects may include models representing objects by using a plurality of points in a three-dimensional virtual coordinate system.

In an embodiment, the processor 110 may obtain a point cloud corresponding to the target object through the LiDAR 120. For example, the processor 110 may identify a point cloud corresponding to the target object based on a plurality of points obtained through the LiDAR 120.

For example, a point cloud may be obtained by performing clustering based on each of the plurality of points obtained by the LiDAR 120 being identified at a specific distance. For example, a point cloud may include a set of points for creating a virtual box that represents a target object.

In an embodiment, the processor 110 may identify the type of the target object based on the point cloud. For example, the type of the target object may include at least one of a bus, a passenger vehicle, a truck, a sport utility vehicle (SUV), a van, a rubber-cone, or a marker, or any combination thereof. The type of the target object is not limited to the examples described above.

For example, the processor 110 may identify the type of the target object based on the approximate shape of the point cloud.

In an embodiment, the processor 110 may identify a model corresponding to the type of the target object among models representing objects included in the memory 130.

In an embodiment, the processor 110 may identify a first reference point, which is included in the point cloud and which corresponds to a designated location of the target object. The processor 110 may identify a second reference point, which is included in the model and which corresponds to the designated location of the target object.

In an embodiment, the processor 110 may match a first reference point, which is included in the point cloud and which corresponds to the designated location of the target object, with a second reference point, which is included in the model and which corresponds to the designated location of the target object, based on identifying the type of the target object identified by the point cloud and a model corresponding to the type of the target object among models included in the memory 130.

In an embodiment, the processor 110 may identify a first heading direction of the point cloud, which indicates a moving direction of the target object.

In an embodiment, the processor 110 may identify a second heading direction of the model, which indicates the moving direction of the target object.

In an embodiment, the processor 110 may match the first heading direction of the point cloud, which indicates the moving direction of the target object, with the second heading direction of the model, which indicates the moving direction of the target object. For example, the processor 110 may rotate the second heading direction of the model to match the first heading direction with the second heading direction.

In an embodiment, the processor 110 may identify a ratio occupied by the point cloud in the model based on matching the first heading direction of the point cloud, which indicates the moving direction of the target object, with the second heading direction of the model, which indicates the moving direction of the target object. The ratio may represent, for example, a proportion, between the point cloud and the model, relative to the model overall. In other words, the ratio may represent a proportion (e.g., a ratio), of the model, that overlaps with the point cloud and the model. For example, a ratio of 30% may indicate that 30% of the model overlaps with the point cloud.

For example, the processor 110 may identify the ratio, which is occupied by the point cloud in the model, based on identifying the matching ratio between the plurality of first points included in the point cloud and the second a plurality of points included in the model.

In an embodiment, the processor 110 may determine the occlusion level of the point cloud based on the ratio occupied by the point cloud in the model.

In an embodiment, the point cloud whose occlusion level is determined may be used to train a neural network model. For example, the point cloud whose occlusion level is determined may be converted into a training data set for training a neural network model. For example, the point cloud whose occlusion level is determined may be converted into a training data set for training a neural network model that identifies an external object for autonomous driving of a vehicle.

In an embodiment, the processor 110 may express a point cloud in a three-dimensional virtual coordinate system. The processor 110 may split an area, in which the point cloud is identified, in the three-dimensional virtual coordinate system. For example, the processor 110 may split the area, in which the point cloud is identified, based on minimum and maximum values of x-axis coordinates of a plurality of first points included in the point cloud, minimum and maximum values of y-axis coordinates thereof, and minimum and maximum values of z-axis coordinates thereof.

In an embodiment, the processor 110 may identify a first center point of the area (or space) where the point cloud is identified. For example, the first center point of the area (or space) where the point cloud is identified may include an intersection point connecting vertices of a rectangular parallelepiped including the point cloud in the three-dimensional virtual coordinate system.

In an embodiment, the processor 110 may identify a second center point of the model. For example, the second center point of the model may include an intersection point connecting vertices of a rectangular parallelepiped including the model expressed in the three-dimensional virtual coordinate system.

For example, the second center point of the model may be located at (0, 0, 0) in the three-dimensional virtual coordinate system. For example, the model may be normalized to a size of [−1, 1].

In an embodiment, the processor 110 may identify the first center point corresponding to an intersection point connecting vertices of a first rectangular parallelepiped including the point cloud. The processor 110 may identify the second center point corresponding to the intersection point connecting vertices of the second rectangular parallelepiped including the model. The processor 110 may match the first center point with the second center point. The processor 110 may match the first reference point of the point cloud with the second reference point of the model based on matching the first center point and the second center point.

In an embodiment, the processor 110 may adjust at least one of a first size of the point cloud, or a second size of the model, or any combination thereof. For example, the processor 110 may scale the first size of the point cloud to correspond to the second size of the model. For example, the processor 110 may scale the second size of the model to correspond to the first size of the point cloud.

For example, the processor 110 may change at least one of the model's width, length, or height, or any combination thereof. For example, the processor 110 may change at least one of the point cloud's width, length, or height, or any combination thereof.

For example, the processor 110 may scale the second size of the model to the first size of the point cloud based on changing at least one of the model's width, length, or height, or any combination thereof.

For example, the processor 110 may scale the first size of the point cloud to the second size of the model based on changing at least one of the point cloud's width, length, or height, or any combination thereof.

In an embodiment, the processor 110 may match the first heading direction with the second heading direction based on scaling the first size to the second size.

In an embodiment, the processor 110 may match the first heading direction with the second heading direction based on scaling the second size to the first size.

In an embodiment, the processor 110 may identify pre-designated horizontal resolution and pre-designated vertical resolution based on the horizontal angle range and vertical angle range of the LiDAR 120. The processor 110 may split the point cloud by using grids based on the pre-designated horizontal resolution and the pre-designated vertical resolution. The processor 110 may identify voxels split by grids.

In an embodiment, the processor 110 may identify the ratio occupied by the point cloud in the model based on the split grids. The processor 110 may identify the ratio occupied by the point cloud in the model based on the split grids and may determine the occlusion level of the point cloud (e.g., the occlusion level of the target object) based on the ratio occupied by the point cloud in the model. The processor 110 may cause control (e.g., movement) of a vehicle (e.g., a host vehicle that employs a vehicle control apparatus of one or more embodiments of the present disclosure) based on the occlusion level of the target object.

In an embodiment, the processor 110 may identify a first shaded area (or space) of the point cloud. The processor 110 may identify a second shaded area (or space) of the model.

For example, the first shaded area (or space) or the second shaded area (or space) may include an area (or space) incapable of being observed by the LiDAR 120.

In an embodiment, the processor 110 may identify a point corresponding to all or part of the target object in all or part of the first shaded area (or space).

For example, the processor 110 may add a voxel, in which a point corresponding to all or part of the target object is present, to a first occupation voxel based on identifying a point corresponding to all or part of the target object in all or part of the first shaded area (or space).

In an embodiment, the processor 110 may identify a point that represents all or part of the target object in all or part of the second shaded area (or space).

For example, the processor 110 may add a voxel, in which a point representing all or part of the target object is present, to a second occupation voxel based on identifying a point representing all or part of the target object in all or part of the second shaded area (or space).

In an embodiment, the processor 110 may identify the shortest point (e.g., closest point), which is closest from a vehicle, from among points included in the point cloud. The processor 110 may obtain a second distance obtained by applying a pre-designated ratio to the first distance between the vehicle and the shortest point. The processor 110 may remove points, which are present beyond the second distance (e.g., points that are at least the second distance away from the vehicle), from the point cloud. The processor 110 may obtain the first occupation voxel based on removing points, which are present beyond the second distance, from the point cloud.

In an embodiment, the processor 110 may identify a ratio of the first occupation voxel to the second occupation voxel. For example, the ratio of the first occupation voxel to the second occupation voxel may be referred to as “first occupation voxel/second occupation voxel”. The processor 110 may determine the occlusion level of the point cloud based on the ratio of the first occupation voxel to the second occupation voxel.

For example, the first occupation voxel may include voxels in each of which at least one point is identified in the point cloud.

For example, the second occupation voxel may include voxels in each of which at least one point is identified in the model.

For example, as the ratio of the first occupation voxel to the second occupation voxel is small, there is almost no occlusion. As the ratio of the first occupation voxel to the second occupation voxel is great, the occlusion occurs a lot.

In an embodiment, the processor 110 may perform labeling on the point cloud of which the occlusion level is determined.

In an embodiment, the processor 110 may determine the occlusion level in specific situations. For example, the processor 110 may determine whether to determine the occlusion level, based on at least one of a color of the target object, or a distance between the vehicle and the target object, or any combination thereof.

For example, the processor 110 may perform a process of determining the occlusion level based on the fact that the color of the target object is a second color different from a first color including black.

For example, the processor 110 may temporarily stop a process of determining the occlusion level based on the fact that the color of the target object is the first color including black.

For example, the processor 110 may perform a process of determining the occlusion level based on obtaining a point cloud including the designated number of points or more corresponding to the target object.

For example, the processor 110 may temporarily stop performing the process of determining the occlusion level based on obtaining a point cloud including points, of which the number is smaller than the designated number and which correspond to the target object.

As mentioned above, the processor 110 included in the vehicle control apparatus 100 according to an embodiment may determine the occlusion level of the point cloud based on the point cloud obtained through the LiDAR 120 and the model included in the memory 130. The processor 110 may accurately and quickly determine the occlusion level of the point cloud by determining the occlusion level of the point cloud based on the point cloud and the model. The processor 110 may cause control (e.g., movement) of a vehicle (e.g., a host vehicle that employs a vehicle control apparatus of one or more embodiments of the present disclosure) based on the occlusion level of the point cloud representing the target object.

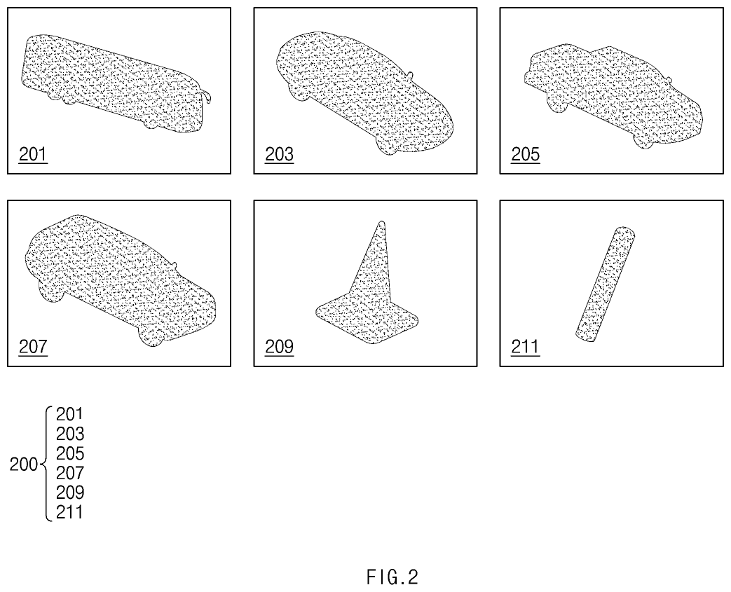

FIG. 2 shows an example of models representing objects included in a memory, in an embodiment of the present disclosure.

Referring to FIG. 2, a memory (e.g., the memory 130 in FIG. 1) of a vehicle control apparatus (e.g., the vehicle control apparatus 100 in FIG. 1) according to an embodiment may include models 200 representing objects.

For example, the models 200 may be used to determine an occlusion level of a target object. For example, each of the models 200 may include type information corresponding to the type of the target object.

For example, a first model 201 among the models 200 may include a model representing a bus.

For example, a second model 203 among the models 200 may include a model representing a passenger vehicle.

For example, a third model 205 among the models 200 may include a model representing at least one of a truck, or a SUV, or any combination thereof.

For example, a fourth model 207 among the models 200 may include a model representing a van.

For example, a fifth model 209 among the models 200 may include a model representing a rubber-cone.

For example, a sixth model 211 among the models 200 may include a model expressing a marker.

The first to sixth models 201 to 211 are shown in FIG. 2, but an embodiment is not limited thereto.

In an embodiment, a processor (e.g., the processor 110 of FIG. 1) may identify a model corresponding to the type of the target object among the models 200 based on identifying the type of the target object.

The processor may determine the occlusion level of the target object by using the model based on identifying the model corresponding to the type of the target object.

For example, the processor may determine the occlusion level of the target object based on comparing a point cloud, which is obtained by using a LiDAR (e.g., the LiDAR 120 in FIG. 1) and which corresponds to the target object, with the model corresponding to the type of the target object.

For example, the processor may determine the occlusion level of the target object based on comparing an overlap degree between the point cloud corresponding to the target object and the model corresponding to the type of the target object.

Hereinafter, a process of determining the occlusion level of the target object will be described later.

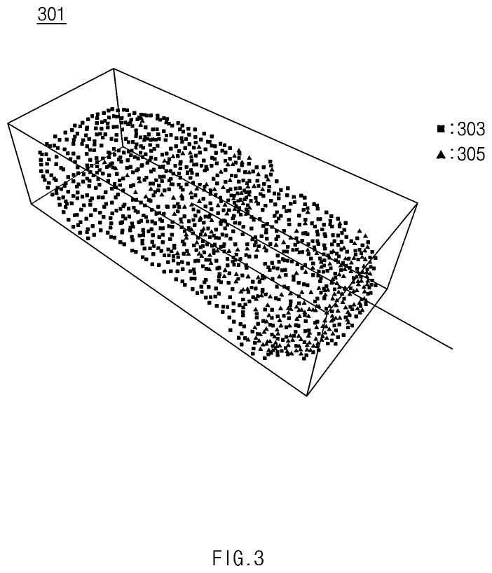

FIG. 3 shows an example of comparing a point cloud corresponding to a target object and a model corresponding to the type of the target object, in an embodiment of the present disclosure.

Referring to FIG. 3, a processor (e.g., the processor 110 in FIG. 1) of a vehicle control apparatus (e.g., the vehicle control apparatus 100 in FIG. 1) according to an embodiment may obtain a point cloud corresponding to a target object through a LiDAR (e.g., the LiDAR 120 in FIG. 1).

Referring to an example 301 in FIG. 3, the processor may identify the type of the target object based on a point cloud 303 corresponding to the target object. The processor may match the point cloud 303 with the model 305 based on identifying a model 305 corresponding to the type of the target object.

For example, the processor may identify a first reference point corresponding to a designated location of the target object in the point cloud 303. The processor may identify a second reference point corresponding to the designated location of the target object in the model 305.

In an embodiment, the processor may match the first reference point and the second reference point based on identifying the first and second reference points.

In an embodiment, the processor may identify the first center point of the point cloud 303 included in the first space. The processor may identify the second center point of the model 305 included in the second space. For example, the first space may include a hexahedron including the point cloud 303. For example, the second space may include a hexahedron including the model 305.

In an embodiment, the processor may identify the first center point of a first space (e.g., the first center point that corresponds to an intersection of lines connecting vertices forming a first space). The processor may identify the second center point of a second space (e.g., the second center point that corresponds to an intersection of lines connecting vertices forming a second space).

In an embodiment, the processor may move the second center point of the model 305 to an origin point of the three-dimensional virtual coordinate system. The processor may scale the second size of the model 305 to the first size of the point cloud 303.

For example, the processor may change at least one of the width, length, or height, or any combination thereof of the model 305. The processor may scale the second size of the model 305 to the first size of the point cloud based on changing at least one of the width, length, or height, or any combination thereof of the model 305.

In an embodiment, the processor may identify the moving direction of the target object. For example, the processor may identify the first heading direction of the point cloud 303, which indicates the moving direction of the target object. For example, the processor may identify the second heading direction of the model 305, which indicates the moving direction of the target object.

For example, the processor may adjust the first heading direction of the point cloud 303 and the second heading direction of the model 305. For example, the processor may match the second heading direction of the model 305 with the first heading direction of the point cloud 303 by adjusting the second heading direction of the model 305

In an embodiment, the processor may identify a distance between the first center point of the point cloud and the three-dimensional virtual coordinate system. The processor may adjust the location of the model based on the distance between the first center point of the point cloud and the three-dimensional virtual coordinate system

In an embodiment, the processor may perform down-sampling on the model based on the distance between the target object and a vehicle. The processor may determine the occlusion level of the point cloud based on performing down-sampling on the model.

In an embodiment, the processor may obtain a point cloud corresponding to the target object by using a different sensor from a LiDAR (e.g., the LiDAR 120 in FIG. 1). The processor may perform down-sampling on the model based on obtaining a point cloud corresponding to the target object by using a sensor different from the LiDAR

As described above, the processor of the vehicle control apparatus according to an embodiment may adjust a first location of the point cloud and a second location of the model. The processor may determine the occlusion level of the point cloud corresponding to the target object based on adjusting the first location and second location. The processor may accurately determine the occlusion level of the point cloud by determining the occlusion level of the point cloud based on adjusting the first location of the point cloud and the second location of the model.

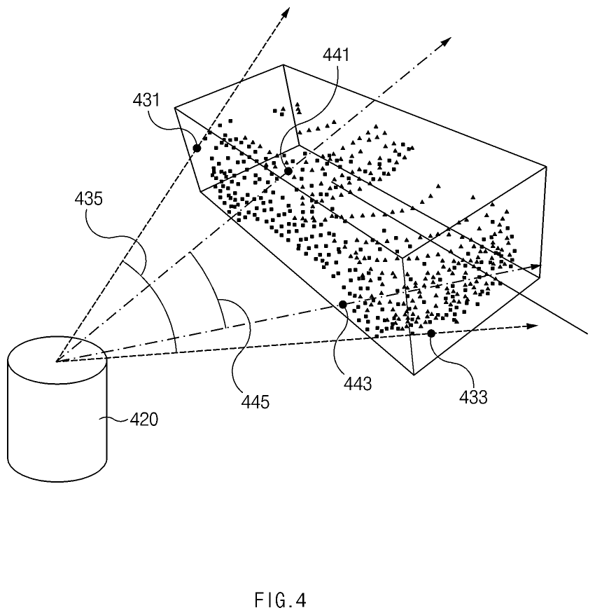

FIG. 4 shows an example of determining an occlusion level of a point cloud by using a point cloud and a model, in an embodiment of the present disclosure.

Referring to FIG. 4, a processor (e.g., the processor 110 in FIG. 1) of a vehicle control apparatus (e.g., the vehicle control apparatus 100 in FIG. 1) according to an embodiment may obtain a point cloud corresponding to a target object through a sensor 420 (e.g., a LiDAR 420). For example, the processor may identify the type of the target object based on obtaining the point cloud corresponding to the target object.

In an embodiment, the processor may identify a model corresponding to the type of the target object among models included in a memory (e.g., the memory 130 in FIG. 1) based on identifying the type of the target object.

In an embodiment, the processor may compare the point cloud and the model based on removing some of points included in the model.

For example, the processor may identify the horizontal angle range and vertical angle range of the LiDAR 420. For example, the processor may identify pre-designated horizontal resolution and pre-designated vertical resolution based on the horizontal angle range and vertical angle range of the LiDAR 420.

For example, the processor may split the point cloud by using grids based on the pre-designated horizontal resolution and the pre-designated vertical resolution.

For example, the processor may identify a first minimum value 431 corresponding to a minimum value of a horizontal direction. The processor may identify a first maximum value 433 corresponding to a maximum value of a horizontal direction.

For example, the processor may identify a second minimum value 443 corresponding to a minimum value of a vertical direction. The processor may identify a second maximum value 441 corresponding to a maximum value of the vertical direction.

In an embodiment, the processor may identify a first line segment extending from the LiDAR 420 to the first minimum value 431. The processor may identify a second line segment extending from the LiDAR 420 to the first maximum value 433. The processor may identify a third line segment extending from the LiDAR 420 to the second minimum value 443. The processor may identify a fourth line segment extending from the LiDAR 420 to the second maximum value 441.

In an embodiment, the processor may identify a first angle 435 between the first line segment and the second line segment. The processor may identify a second angle 445 between the third line segment and the fourth line segment.

In an embodiment, the processor may split the point cloud through grids by using a pre-designated horizontal resolution based on the first angle 435 between the first line segment and the second line segment. The processor may split the point cloud through grids by using a pre-designated vertical resolution based on the second angle 445 between the third line segment and the fourth line segment.

As described above, the processor may split the point cloud by using grids on the basis of the pre-designated horizontal resolution based on the first angle 435 and pre-designated vertical resolution based on the second angle 445

In an embodiment, the processor may identify the ratio occupied by the point cloud in the model based on the split grids. For example, the processor may identify voxels split by grids in each of the point cloud and the model.

For example, the processor may identify the shortest point, which is closest from a vehicle, from among points included in the point cloud.

For example, the processor may identify a first distance between a vehicle and the shortest (e.g., closest) point. The processor may obtain a second distance obtained by applying a pre-designated ratio (e.g., a predetermined multiplier) to the first distance between the vehicle and the shortest point.

For example, the processor may remove points, which are present beyond the second distance (e.g., relative to the vehicle), from the model. For example, because points that are present beyond the second distance are points that are present in an area (or space) incapable of being observed by the LiDAR 420 (e.g., out of a detection range of the sensor, such as the LiDAR 420), the processor may remove points, which are present beyond the second distance, from the model.

In an embodiment, the processor may identify a first shaded area (or space) of the point cloud and a second shaded area (or space) of the model. For example, the first shaded area (or space) or the second shaded area (or space) may refer to an area (or space) incapable of being observed by the LiDAR 420 (e.g., out of a detection range of the sensor, such as the LiDAR 420).

For example, the processor may identify a first voxel, in which a point corresponding to all or part of the target object is present, based on identifying a point corresponding to all or part of the target object in all or part of the first shaded area (or space).

For example, the processor may identify a second voxel, in which a point representing all or part of the target object is present, in all or part of the second shaded area (or space).

In an embodiment, the processor may identify a ratio occupied by a point cloud in the model based on the first voxel and the second voxel.

In an embodiment, the processor may identify the ratio of the first voxel to the second voxel. The processor may determine the occlusion level of the point cloud based on the ratio of the first voxel to the second voxel.

As described above, the processor included in the vehicle control apparatus according to an embodiment may obtain the first voxel of the point cloud and the second voxel of the model. The processor may determine the occlusion level of the point cloud based on the first voxel and the second voxel. The processor may accurately identify the occlusion level of the point cloud by determining the occlusion level of the point cloud based on the first voxel and the second voxel. The processor may cause control (e.g., movement) of a vehicle (e.g., a host vehicle that employs a vehicle control apparatus of one or more embodiments of the present disclosure) based on the occlusion level of the point cloud (e.g., the occlusion level of the target object).

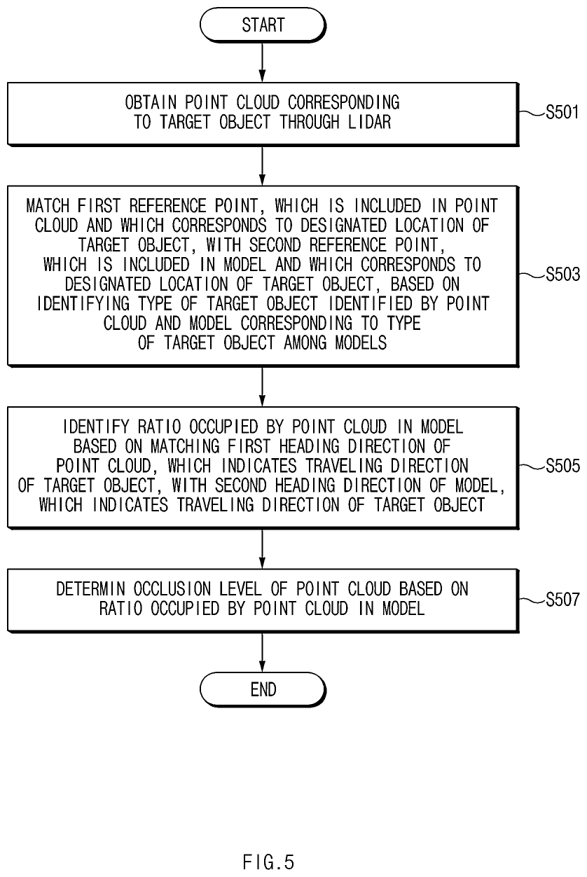

FIG. 5 shows an example of a flowchart associated with a vehicle control method, according to an embodiment of the present disclosure.

Hereinafter, it is assumed that the vehicle control apparatus 100 of FIG. 1 performs the process of FIG. 5. In addition, in a description of FIG. 5, it may be understood that an operation described as being performed by an apparatus is controlled by the processor 110 of the vehicle control apparatus 100.

At least one of operations of FIG. 5 may be performed by the vehicle control apparatus 100 of FIG. 1. Each of the operations in FIG. 5 may be performed sequentially, but is not necessarily sequentially performed. For example, the order of operations may be changed, and at least two operations may be performed in parallel.

Referring to FIG. 5, in operation S501, a vehicle control method according to an embodiment may include an operation of obtaining a point cloud corresponding to a target object through a LiDAR (e.g., the LiDAR 120 in FIG. 1 and/or the LiDAR 420 in FIG. 4).

In operation S503, the vehicle control method according to an embodiment may include an operation of matching a first reference point, which is included in the point cloud and which corresponds to the designated location of the target object, with a second reference point, which is included in the model and which corresponds to the designated location of the target object, based on identifying the type of the target object identified by the point cloud and a model corresponding to the type of the target object among models.

The vehicle control method according to an embodiment may include an operation of identifying a first space in a form of a hexahedron including the point cloud. The vehicle control method according to an embodiment may include an operation of identifying a second space in a form of a hexahedron including the model.

For example, the vehicle control method may include an operation of identifying a first center point that corresponds to an intersection point connecting vertices forming a first space. The vehicle control method may include an operation of identifying a second center point that corresponds to an intersection point connecting vertices forming a second space.

For example, the vehicle control method may include an operation of matching the first center point with the second center point. The vehicle control method may include an operation of matching the first reference point with the second reference point based on matching the first center point with the second center point.

In operation S505, the vehicle control method according to an embodiment may include an operation of identifying a ratio occupied by the point cloud in the model based on matching the first heading direction of the point cloud, which indicates the moving direction of the target object, with the second heading direction of the model, which indicates the moving direction of the target object.

For example, the vehicle control method may include an operation of identifying a first size, which is a size of the point cloud. For example, the vehicle control method may include an operation of identifying a second size, which is a size of the model.

In an embodiment, the vehicle control method may include an operation of matching the first heading direction with the second heading direction based on scaling the second size of the model to the first size of the point cloud.

For example, the vehicle control method may include an operation of scaling the second size of the model to the first size of the point cloud based on changing at least one of a width, a length, or a height, or any combination thereof of the model.

In operation S507, the vehicle control method according to an embodiment may include an operation of determining an occlusion level of the point cloud based on the ratio occupied by the point cloud in the model.

For example, the point cloud whose occlusion level is determined may be used to train a neural network model. The neural network model may be trained based on the point cloud and/or the occlusion level.

The vehicle control method according to an embodiment may include an operation of identifying the horizontal angle range and vertical angle range of a LiDAR. For example, the vehicle control method may include an operation of identifying pre-designated horizontal resolution and pre-designated vertical resolution based on the horizontal angle range and vertical angle range of the LiDAR.

For example, the vehicle control method may include an operation of splitting the point cloud by using grids based on the pre-designated horizontal resolution and the pre-designated vertical resolution.

For example, the vehicle control method may include an operation of identifying the ratio occupied by the point cloud in the model based on the split grids.

The vehicle control method according to an embodiment may include an operation of identifying voxels split by the grids in each of the point cloud and the model.

For example, the vehicle control method may include an operation of identifying a first shaded area (or space) of the point cloud and a second shaded area (or space) of the model. For example, the first shaded area (or space) or the second shaded area (or space) may include an area (or space) incapable of being observed by the LiDAR.

For example, the vehicle control method may include an operation of adding a voxel, in which a point corresponding to all or part of the target object is present, to a first occupation voxel based on identifying a point corresponding to all or part of the target object in all or part of the first shaded area (or space).

For example, the vehicle control method may include an operation of adding a voxel, in which a point representing all or part of the target object is present in all or part of the second shaded area (or space), to a second occupation voxel.

For example, the vehicle control method may include an operation of identifying a ratio occupied by a point cloud in the model based on the first occupation voxel and the second occupation voxel.

The vehicle control method according to an embodiment may include an operation of identifying the shortest point, which is closest from the vehicle, from among points included in the point cloud.

For example, the vehicle control method may include an operation of identifying a first distance between the vehicle and the shortest point. The vehicle control method may include an operation of obtaining a second distance obtained by applying a pre-designated ratio (e.g., a predetermined multiplier) to the first distance between the vehicle and the shortest point.

For example, the vehicle control method may include an operation of removing points, which are present beyond the second distance, from the model. For example, the vehicle control method may include an operation of obtaining the second occupation voxel based on removing points, which are present beyond the second distance, from the model.

The vehicle control method according to an embodiment may include an operation of determining the occlusion level of the point cloud based on a ratio of the first occupation voxel to the second occupation voxel.

The vehicle control method may include an operation of performing labeling (e.g., based on the occlusion level) on the point cloud of which the occlusion level is determined.

As described above, the vehicle control method may include an operation of determining the occlusion level of the point cloud based on the point cloud corresponding to the target object and the model corresponding to the target object among models stored in the memory. The vehicle control method may accurately identify the occlusion level of the point cloud by determining the occlusion level of the point cloud.

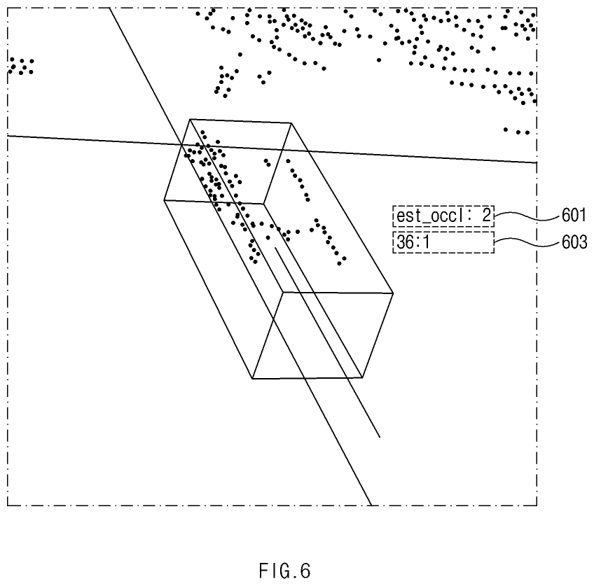

FIG. 6 shows an example of applying the present disclosure.

Referring to FIG. 6, a vehicle control apparatus (e.g., the vehicle control apparatus 100 of FIG. 1) according to an embodiment may identify an occlusion level of a point cloud corresponding to a target object.

For example, in FIG. 6, a first text 601 may include an example of determining the occlusion level by applying the present technology. For example, “est_occl: 2” in the first text 601 may mean that the occlusion level of the point cloud, which is determined if the present technology is applied, is 2.

The second text 603 in FIG. 6 may mean that a ground-truth (GT) label is written as 1 before the present technology is applied. For example, “36” included in the second text 603 may include the number of the point cloud corresponding to the target object. For example, “1” included in the second text 603 may mean that the existing GT label is written as 1.

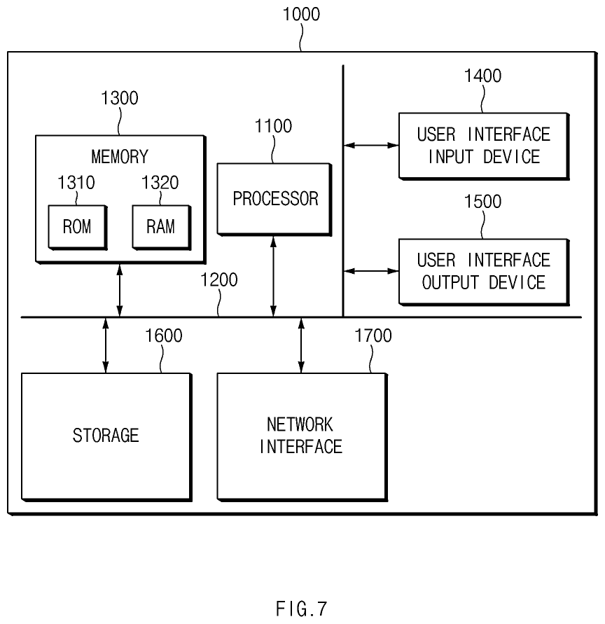

FIG. 7 shows a computing system related to a vehicle control apparatus or vehicle control method, according to an embodiment of the present disclosure.

Referring to FIG. 7, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

The present technology may identify an occlusion level of a point cloud corresponding to a target object obtained through a LiDAR.

Moreover, the present technology may accurately and quickly identify the occlusion level of the point cloud by identifying the occlusion level of the point cloud based on using models included in a memory.

Furthermore, the present technology may correct an occlusion level incorrectly labeled in a point cloud.

Besides, a variety of effects directly or indirectly understood through the specification may be provided.

Hereinabove, although the present disclosure is described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control apparatus comprising:
a sensor;
memory storing a plurality of models, each model of the plurality of models corresponding to a respective object type; and
a processor configured to:
obtain, via the sensor, a point cloud corresponding to a target object;
match, based on identifying a target model, of the plurality of models, that corresponds to an object type of the target object, a first reference point, which is included in the point cloud and which corresponds to a designated location of the target object, with a second reference point, which is included in the target model and which corresponds to the designated location;
determine, based on matching a first heading direction of the point cloud with a second heading direction of the target model, a proportion, of the target model, that overlaps with the point cloud, wherein each of the first heading direction and the second heading direction indicates a moving direction of the target object;
determine, based on the proportion, an occlusion level of the point cloud; and
for controlling a vehicle, output a signal indicating the occlusion level of the point cloud.

2. The vehicle control apparatus of claim 1, wherein the processor is further configured to train a neural network model based on the point cloud and the occlusion level.

3. The vehicle control apparatus of claim 1, wherein the processor is configured to match the first reference point with the second reference point by:
determining a first space in a form of a first hexahedron comprising the point cloud;
determining a second space in a form of a second hexahedron comprising the target model;
determining a first center point, corresponding to an intersection of lines connecting vertices forming the first space, and a second center point, corresponding to an intersection of lines connecting vertices forming the second space; and
matching the first reference point with the second reference point based on matching the first center point with the second center point.

4. The vehicle control apparatus of claim 1, wherein the processor is further configured to:
match the first heading direction with the second heading direction based on scaling a first size of the target model to match a second size of the point cloud.

5. The vehicle control apparatus of claim 4, wherein the processor is configured to:
scale the first size of the target model to match the second size of the point cloud based on changing at least one of a width, a length, or a height of the target model.

6. The vehicle control apparatus of claim 1, wherein the processor is configured to determine the proportion by:
determining, based on a horizontal angle range of the sensor, a predetermined horizontal resolution;
determining, based on a vertical angle range of the sensor, a predetermined vertical resolution;
splitting, based on the predetermined horizontal resolution and the predetermined vertical resolution, the point cloud into grids; and
determining, based on the grids, the proportion.

7. The vehicle control apparatus of claim 6, wherein the processor is configured to determine the proportion further by:
determining voxels split by the grids in each of the point cloud and the target model;
determining a first shaded area of the point cloud and a second shaded area of the target model;
adding, based on identifying a first point corresponding to at least part of the target object in at least part of the first shaded area, a first voxel, comprising the first point, to a first occupation voxel;
adding a second voxel, comprising a second point corresponding to at least part of the target object in at least part of the second shaded area, to a second occupation voxel; and
determining the proportion based on the first occupation voxel and the second occupation voxel,
wherein the first shaded area and the second shaded area are out of a detection range of the sensor,
wherein the first occupation voxel comprises voxels having at least one point that is identified in the point cloud, and
wherein the second occupation voxel comprises voxels having at least one point that is identified in the target model.

8. The vehicle control apparatus of claim 7, wherein the processor is further configured to:
determine a closest point, among points in the point cloud, to the vehicle;
determining, based on applying a predetermined multiplier to a first distance between the vehicle and the closest point, a second distance; and
determining the second occupation voxel based on removing any points, from the point cloud, that are at least the second distance away from the vehicle.

9. The vehicle control apparatus of claim 7, wherein the processor is configured to determine the occlusion level by:
determining the occlusion level of the point cloud based on a ratio of the first occupation voxel to the second occupation voxel.

10. The vehicle control apparatus of claim 1, wherein the processor is further configured to:
perform, based on the occlusion level, labeling on the point cloud.

11. The vehicle control apparatus of claim 1, wherein the processor is further configured to:
determine whether to determine the occlusion level, based on at least one of a color of the target object or a distance between the vehicle and the target object.

12. A vehicle control method comprising:
obtaining, by a processor via a sensor, a point cloud corresponding to a target object;
matching, based on identifying a target model that corresponds to an object type of the target object, a first reference point, which is included in the point cloud and which corresponds to a designated location of the target object, with a second reference point, which is included in the target model and which corresponds to the designated location;
determining, based on matching a first heading direction of the point cloud, with a second heading direction of the target model, a proportion, of the target model, that overlaps with the point cloud, wherein each of the first heading direction and the second heading direction indicates a moving direction of the target object;
determining, based on the proportion, an occlusion level of the point cloud; and
for controlling a vehicle, outputting a signal indicating the occlusion level of the point cloud.

13. The method of claim 12, further comprising training a neural network model based on the point cloud and the occlusion level.

14. The method of claim 12, wherein the matching of the first reference point with the second reference point comprises:
determining a first space in a form of a first hexahedron comprising the point cloud;
determining a second space in a form of a second hexahedron comprising the target model;
determining a first center point, corresponding to an intersection of lines connecting vertices forming the first space, and a second center point, corresponding to an intersection of lines connecting vertices forming the second space; and
matching the first reference point with the second reference point based on matching the first center point with the second center point.

15. The method of claim 12, further comprising:
matching the first heading direction with the second heading direction based on scaling a first size of the target model to match a second size of the point cloud.

16. The method of claim 15, wherein the scaling comprises:
scaling the first size of the target model to match the second size of the point cloud based on changing at least one of a width, a length, or a height of the target model.

17. The method of claim 12, wherein the determining of the proportion comprises:
determining, based on a horizontal angle range of the sensor, a predetermined horizontal resolution;
determining, based on a vertical angle range of the sensor, a predetermined vertical resolution;
splitting, based on the predetermined horizontal resolution and the predetermined vertical resolution, the point cloud into grids; and
determining, based on the grids, the proportion.

18. The method of claim 17, wherein the determining of the proportion comprises:
determining voxels split by the grids in each of the point cloud and the target model;
determining a first shaded area of the point cloud and a second shaded area of the target model;
adding, based on identifying a first point corresponding to at least part of the target object in at least part of the first shaded area, a first voxel, comprising the first point, to a first occupation voxel;
adding a second voxel, comprising a second point corresponding to at least part of the target object in at least part of the second shaded area, to a second occupation voxel; and
determining the proportion based on the first occupation voxel and the second occupation voxel,
wherein the first shaded area and the second shaded area are out of a detection range of the sensor,
wherein the first occupation voxel comprises voxels having at least one point that is identified in the point cloud, and
wherein the second occupation voxel comprises voxels having which at least one point that is identified in the target model.

19. The method of claim 18, further comprising:
determining a closest point, among points in the point cloud, to the vehicle;
determining, based on applying a predetermined multiplier to a first distance between the vehicle and the closest point, a second distance;
determining the second occupation voxel based on removing any points, from the point cloud, that are at least the second distance away from the vehicle; and
determining the occlusion level of the point cloud based on a ratio of the first occupation voxel to the second occupation voxel.

20. The method of claim 12, further comprising:
determining whether to determine the occlusion level, based on at least one of a color of the target object or a distance between the vehicle and the target object.
